(19) United States
(12) Patent Application Publication
(10) Pub. No.: US 2021/0396332 A1
(43) Pub. Date: Dec. 23, 2021

(54) TRENCHLESS SYSTEM FOR THE SUBSURFACE DELIVERY OF A POLYMER-BASED MESH

(71) Applicants: Saudi Arabian Oil Company, Dhahran (SA); Overpipe SAS, Meyreuil (FR)

(72) Inventors: Iqbal Hussain, Khobar (SA); Yannick Joubeaux, Saint-Marc-Jaumegarde (FR); Thibault Villette, Dhahran (SA); Waheed Alrafaei, Dhahran (SA)

(21) Appl. No.: 16/904,344

(22) Filed: Jun. 17, 2020

(51) Int. Cl. F16L 1/11; F16L 57/06

(52) U.S. Cl. CPC F16L 1/11; F16L 57/06

(57) ABSTRACT

A trenchless system for subsurface delivery of a polymer-based mesh to protect an underground structure is provided. The system includes: a body for moving above the ground and over the underground structure while the system delivers the mesh below the ground; a polymer mesh supply coupled to the body and configured to supply the mesh during the moving of the body; and a ripper assembly coupled to the body and configured to move through the ground in response to the moving of the body without digging a trench and while receiving and delivering the supplied mesh below the ground and above the underground structure to protect the underground structure. In an embodiment, the polymer mesh supply includes a polymer mesh spool configured to rotate during the moving of the body in order to supply the mesh. A method of trenchless subsurface delivery of the mesh is also provided.

### FIELD OF THE DISCLOSURE

The present disclosure relates generally to protecting underground assets, such as pipelines, and specifically to a trenchless system for the subsurface insertion or installation of a polymer-based mesh that protects the assets.

### BACKGROUND OF THE DISCLOSURE

The security and safety around underground infrastructure, such as oil and gas transportation pipelines, has become an important endeavor. For instance, each year, numerous pipeline accidents and resulting damage occur because of third party incidents, such as from diggers or excavators working in the vicinity of the existing pipelines that are insufficiently spotted or insufficiently protected. Many of these accidents are caused by human encroachment, which increases as remote areas become more urbanized. For example, increases in population and urbanization lead to increases in development activities such as construction, which increases the likelihood of third-party damages to underground assets. Such pipeline (or other underground infrastructure failures) are several times more frequent in developed areas than in rural areas. Over time, given the rapidly expanding urban development in many parts of the world, the existing pipeline corridors are encroached upon by communities, business ventures, or other land development that pose a direct threat of third-party damage to such pipelines.

It is in regard to these and other problems in the art that the present disclosure is directed to provide a technical solution for an effective trenchless system for the subsurface insertion or installation of a polymer-based mesh that protects underground infrastructure such as pipelines.

### SUMMARY OF THE DISCLOSURE

According to a first aspect of the disclosure, a trenchless system for subsurface delivery of a polymer-based mesh to protect an underground structure is provided. The system comprises: a body for moving above the ground and over the underground structure while the system delivers the polymer-based mesh below the ground; a polymer mesh supply coupled to the body and configured to supply the mesh during the moving of the body; and a ripper assembly coupled to the body and configured to move through the ground in response to the moving of the body without digging a trench and while receiving and delivering the supplied mesh below the ground and above the underground structure to protect the underground structure.

In an embodiment consistent with the above, the polymer mesh supply comprises a polymer mesh spool configured to rotate during the moving of the body in order to supply the mesh.

In an embodiment consistent with the above, the ripper assembly comprises: a first ripper arm coupled to the body and configured to: extend into and move through the ground in response to the moving of the body; and serve as a conduit for the supplied mesh from the polymer mesh supply to a delivery depth below the ground; a second ripper arm coupled to the body and configured to extend into and move through the ground in response to the moving of the body; and a ripper blade coupled to the first and second ripper arms and configured to: move through the ground at the delivery depth in response to the moving of the extended first and second ripper arms; and receive and deliver the supplied mesh from the extended first ripper arm at the delivery depth below the ground.

In an embodiment consistent with the above, the ripper blade comprises a tilt system for adjusting a vertical tilt of the ripper blade during the moving of the ripper blade.

In an embodiment consistent with the above, the first and second ripper arms are configured to adjust the delivery depth below the ground in response to adjusting the vertical tilt of the ripper blade while the body remains fixed in height above the ground.

In an embodiment consistent with the above, the first and second ripper arms are further configured to adjust in height above the ground in response to adjusting the vertical tilt of the ripper blade while the body remains fixed in height above the ground.

In an embodiment consistent with the above, the first and second ripper arms are configured to detach from and attach to the body before the moving of the body.

In an embodiment consistent with the above: the polymer mesh supply comprises a first polymer mesh supply configured to supply the mesh to the first ripper arm, and a second polymer mesh supply configured to supply the mesh to the second ripper arm; the first ripper arm is further configured to serve as a conduit for the supplied mesh from the first polymer mesh supply to the ripper blade at the delivery depth below the ground; the second ripper arm is further configured to serve as a conduit for the supplied mesh from the second polymer mesh supply to the ripper blade at the delivery depth below the ground; and the ripper blade is further configured to receive and deliver the supplied mesh from the second ripper arm at the delivery depth below the ground.

In an embodiment consistent with the above: the first polymer mesh supply comprises a first polymer mesh spool configured to rotate while the body moves in order to supply the mesh to the first ripper arm; and the second polymer mesh supply comprises a second polymer mesh spool configured to rotate while the body moves in order to supply the mesh to the second ripper arm.

In an embodiment consistent with the above: the ripper blade comprises a divider configured to separate the supplied mesh from the first and second ripper arms; and the ripper blade is further configured to overlap the separated mesh supplied from the first and second ripper arms at the delivery depth below the ground.

In an embodiment consistent with the above, the first and second ripper arms are further configured to angle inward from the body to the ripper blade while extending into the ground such that the extended first and second ripper arms are closer to each other at the delivery depth below the ground than at a height above the ground.

In an embodiment consistent with the above, the body comprises an attachment point for attaching the body to a motorized vehicle configured to supply a driving force for moving the body above the ground while the system delivers the mesh below the ground.

In an embodiment consistent with the above, the system further comprises a surface compactor coupled to the body and configured to compact the surface of the ground below the body during the moving of the body.

According to another aspect of the disclosure, a method of trenchless subsurface delivery of a polymer-based mesh to protect an underground structure is provided. The method comprises: moving a body of a polymer mesh delivery system above the ground and over the underground structure; and delivering the polymer-based mesh below the ground by the system during the moving of the body. Delivering the mesh comprises: supplying the mesh from a polymer mesh supply coupled to the body; and moving a ripper assembly through the ground in response to the moving of the body without digging a trench and while receiving and delivering the supplied mesh below the ground and above the underground structure to protect the underground structure, wherein the ripper assembly is coupled to the body.

In an embodiment consistent with the method described above, the polymer mesh supply comprises a polymer mesh spool, and supplying the mesh comprises rotating the polymer mesh spool during the moving of the body.

In an embodiment consistent with the method described above, delivering the mesh further comprises: extending a first ripper arm of the ripper assembly into the ground and moving the extended first ripper arm through the ground in response the to the moving of the body, the first ripper arm being coupled to the body: using the extended first ripper arm as a conduit for the supplied mesh from the polymer mesh supply to a delivery depth below the ground; extending a second ripper arm of the ripper assembly into the ground and moving the extended second ripper arm through the ground in response the to the moving of the body, the second ripper arm being coupled to the body: moving a ripper blade of the ripper assembly through the ground at the delivery depth in response to the moving of the extended first and second ripper arms, the ripper blade being coupled to the first and second ripper arms; and receiving and delivering the supplied mesh from the extended first ripper arm by the moving ripper blade at the delivery depth below the ground.

In an embodiment consistent with the method described above, the method further comprises adjusting a vertical tilt of the ripper blade using a tilt system of the ripper blade during the moving of the ripper blade.

In an embodiment consistent with the method described above, the method further comprises adjusting the delivery depth below the ground of the first and second ripper arms in response to adjusting the vertical tilt of the ripper blade while the body remains fixed in height above the ground.

In an embodiment consistent with the method described above, the method further comprises adjusting a height above the ground of the first and second ripper arms in response to adjusting the vertical tilt of the ripper blade while the body remains fixed in height above the ground.

In an embodiment consistent with the method described above, the method further comprises detaching the first and second ripper arms from and attaching the first and second ripper arms to the body before the moving of the body.

In an embodiment consistent with the method described above, delivering the mesh further comprises: supplying the mesh to the first ripper arm by a first polymer mesh supply of the polymer mesh supply; supplying the mesh to the second ripper arm by a second polymer mesh supply of the polymer mesh supply; using the extended first ripper arm as a conduit for the supplied mesh from the first polymer mesh supply to the ripper blade at the delivery depth below the ground; using the extended second ripper arm as a conduit for the supplied mesh from the second polymer mesh supply to the ripper blade at the delivery depth below the ground; and receiving and delivering the supplied mesh from the extended second ripper arm by the moving ripper blade at the delivery depth below the ground.

In an embodiment consistent with the method described above, the first polymer mesh supply comprises a first polymer mesh spool and the second polymer mesh supply comprises a second polymer mesh spool, and supplying the mesh comprises rotating the first and second polymer mesh spools during the moving of the body.

In an embodiment consistent with the method described above, delivering the mesh further comprises: separating, by a divider of the ripper blade, the supplied mesh from the first and second ripper arms; and overlapping, by the ripper blade, the separated mesh supplied from the first and second ripper arms at the delivery depth below the ground.

In an embodiment consistent with the method described above, delivering the mesh further comprises angling the first and second ripper arms inward from the body to the ripper blade while extending into the ground such that the extended first and second ripper arms are closer to each other at the delivery depth below the ground than at a height above the ground.

In an embodiment consistent with the method described above, the method further comprises: attaching the body to a motorized vehicle at an attachment point of the body; and supplying, by the motorized vehicle, a driving force for moving the body above the ground while the system delivers the mesh below the ground.

In an embodiment consistent with the method described above, the method further comprises compacting, by a surface compactor coupled to the body, the surface of the ground below the body during the moving of the body.

Any combinations of the various embodiments and implementations disclosed herein can be used. These and other aspects and features can be appreciated from the following description of certain embodiments together with the accompanying drawings and claims.

### BRIEF DESCRIPTION OF THE DRAWINGS

FIG. 1 is an illustration of an example trenchless polymer mesh delivery system, according to an embodiment.

FIG. 2 is an illustration of an example trenchless polymer mesh delivery system, according to an embodiment.

FIG. 3 is an illustration of an example trenchless polymer mesh delivery system, according to an embodiment.

FIG. 4 is an illustration of an example motorized polymer mesh delivery system, according to an embodiment.

FIG. 5 is a flow diagram of an example method of trenchless subsurface delivery of a polymer-based mesh to protect an underground structure, according to an embodiment.

It is noted that the drawings are illustrative and not necessarily to scale, and that the same or similar features have the same or similar reference numerals throughout.

### DETAILED DESCRIPTION OF CERTAIN EMBODIMENTS OF THE DISCLOSURE

In various example embodiments, techniques for the trenchless subsurface insertion or installation of a polymer-based mesh to protect, for example, buried pipelines, buried assets, or other buried or subsurface structures against above-ground third party impact damage are provided. Example systems and methods include methods of subsurface delivery, apparatuses for subsurface delivery, and subsurface protection systems to protect existing buried assets such as pipelines or optic cables against third party damage such as caused accidentally by an excavator. Example techniques provide for the subsurface insertion of a protective mesh without requiring trenching or backfilling of earth or soil, which helps minimize costs. For instance, such a mesh protective system can require 20 to 50 times less material than comparable high-density polyethylene (HDPE) slabs, which helps realize further cost savings. Polyethylene mesh is commercially available, which eliminates the need for any specific manufacturing equipment as might be needed for comparable concrete or polymer slabs. Further, the risks of disrupting existing cathodic protection of buried pipelines is significantly decreased when using polymer meshes as the mesh is not reinforced with metal and is continuously perforated, which allows a continuous flow of current within the soil.

As discussed earlier, there are a number of problems associated with protecting underground structures from above-ground impact damage. While trenching and back-filling can be used to install protective structures, such as concrete slabs, above the pipelines, this can be an expensive and invasive procedure, requiring significant amounts of heavy equipment (e.g., cranes, trucks) and personnel. Concrete is also challenging to move in case of necessary maintenance operations. Prefabricated polymer slabs (e.g., high-density polyethylene or HDPE) can be used in lieu of concrete slabs to provide similar protection and with less weight, but they still require trenching and back filling to install over existing pipelines. Similarly, polymer meshes are significantly lighter than either concrete or polymer slabs, but they provide less protection for the same surface area of coverage. As such, to provide adequate protection from polymer meshes requires more surface area coverage than with slabs, which leads to more (e.g., wider) trenching and back filling than with slabs.

Accordingly, in example embodiments, systems and methods are provided for trenchless installation of an underground layer of polymer mesh in order to form an impact-resistant barrier protecting buried pipelines or other buried assets from above-ground accidental third-party damage such as that caused by an excavator. The underground delivery of polymer mesh is performed without having to open a trench for the length of the buried pipeline or asset, which reduces the number of man hours worked and avoids the costs associated with digging and backfilling the trench. In addition, the polymer mesh protection system requires 20 to 50 times less material than an HDPE slab solution, which eliminates costs associated with the delivering of slabs. Further, there is no need to manufacture specific equipment such as slabs since polymer mesh is commercially available. Moreover, the risks of disrupting cathodic protection of buried pipelines is significantly decreased with the polymer mesh since the mesh is not reinforced with metal and the porous design of a mesh does not hinder the soil's conductive properties.

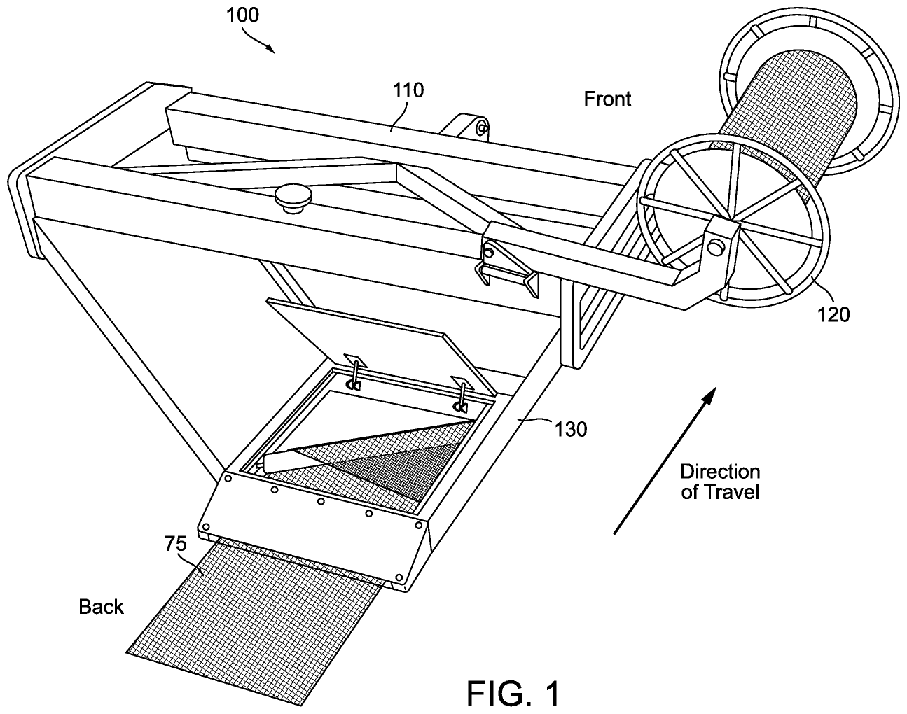

According to various embodiments, an apparatus for trenchless subsurface delivery, a method of trenchless subsurface delivery, and a trenchless subsurface protection system are provided. These techniques protect existing buried assets such as pipelines, optic cables, or any other existing valuable buried asset or subsurface infrastructure, against third-party damage such as caused accidentally by an excavator. In some embodiments, the apparatus is an electromechanical system for the subsurface trenchless delivery of polymer mesh. Once installed, the mesh forms an efficient underground protection of buried structures, against accidental third-party damage such as from heavy earth moving equipment. Here, buried structures can be any sort of buried valuable asset such as pipelines, electric cabling, or fiber optics. There are numerous variations of the apparatus, example embodiments of which are illustrated in FIGS. 1-4.

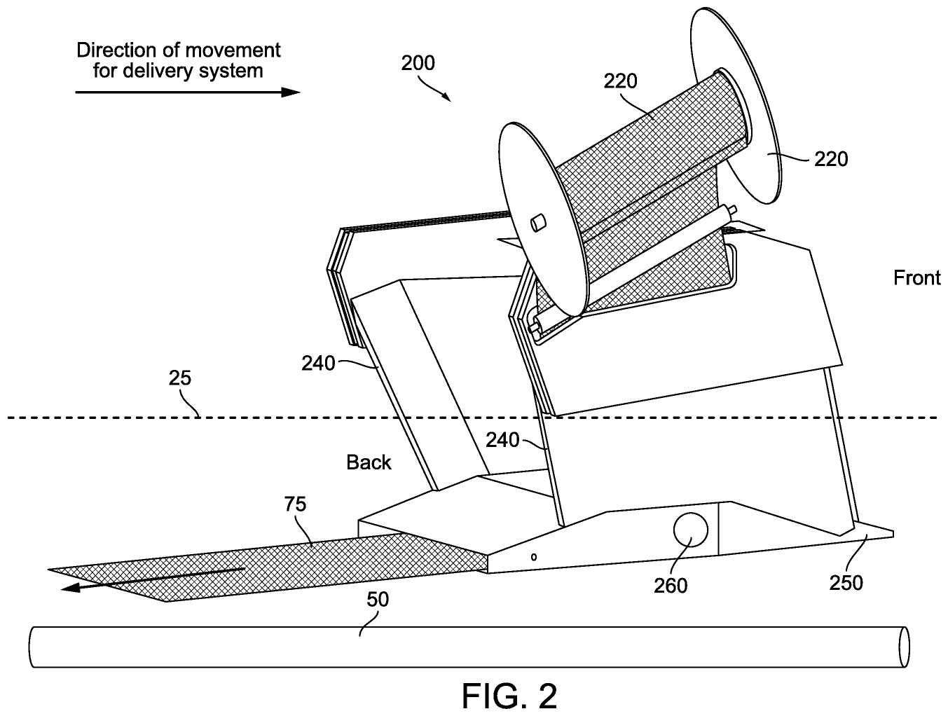

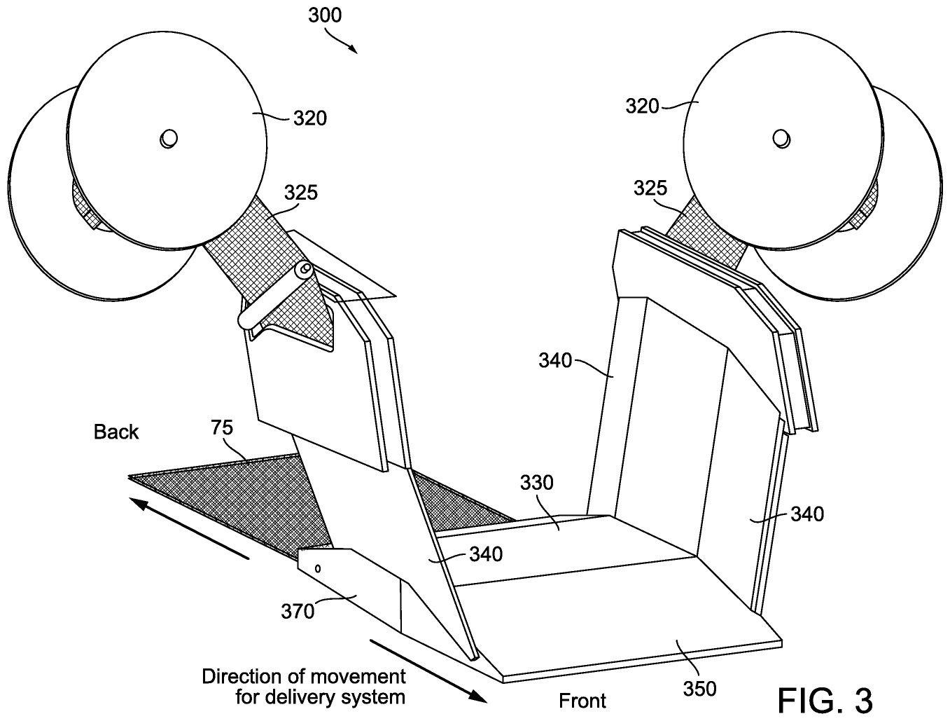

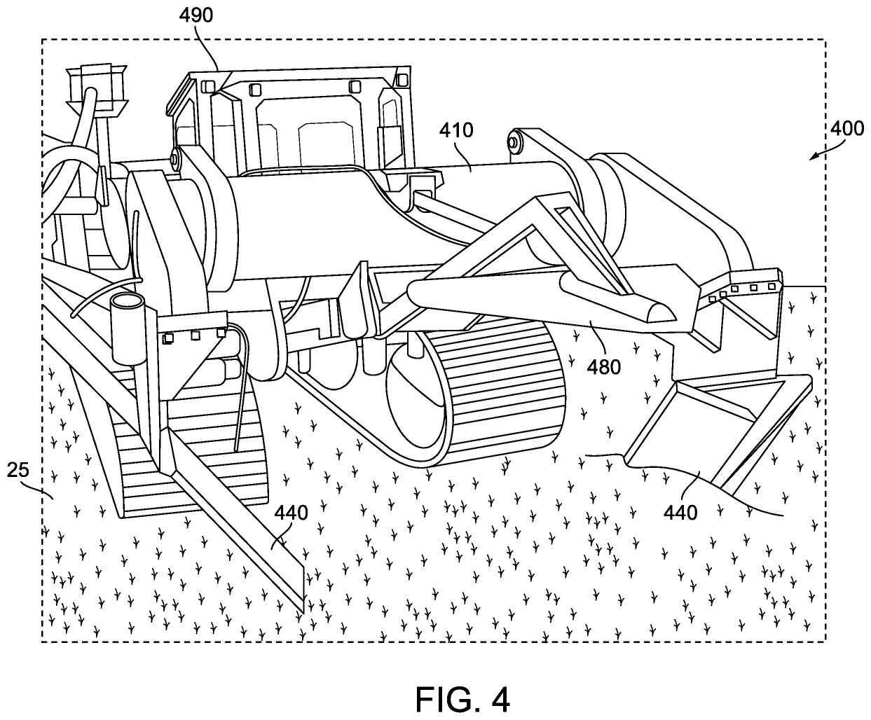

FIG. 1 is an illustration of an example trenchless polymer mesh delivery system 100, according to an embodiment. FIG. 2 is an illustration of an example trenchless polymer mesh delivery system 200, according to an embodiment. FIG. 3 is an illustration of an example trenchless polymer mesh delivery system 300, according to an embodiment. FIG. 4 is an illustration of an example motorized polymer mesh delivery system 400, according to an embodiment. The polymer mesh delivery systems 100, 200, 300, 400 exhibit different features and combinations of features, some of which operate above ground (such as ground 25) and some below ground. These mesh delivery systems 100, 200, 300, and 400 deliver a polymer mesh structure, such as polymer mesh structure 75, over an underground structure being protected, such as buried pipeline 50.

According to various embodiments, the features of these mesh delivery systems include, for example, at least one rotating spool (such as polymer reel 120 and polymer mesh spools 220 and 320), containing the polymer mesh (such as polymer mesh 325, as in HDPE mesh). A further spool (as in the mesh delivery system 300 of FIG. 3) allows a further mesh layer on top of the other, which reinforces the subsurface polymer mesh structure. In some embodiments, the two mesh layers do not overlap (e.g., side by side), which allows a greater width of the polymer mesh layer to be delivered. In some other embodiments, the two mesh layers partially overlap, which provides some degree of reinforced protection and some degree of increased width of coverage, depending on the amount of overlap.

The features further include a subsurface bladed carriage, such as subsurface delivery system 130 or soil ripper assembly 330 to lay the polymer mesh underground at the desired delivery depth. For example, components from a soil ripper (or “ripper” for short), such as bladed structures that narrow in the direction of the movement through the soil, can be used for the subsurface bladed carriage. These soil ripper blades can include opposing ripper arms extending and angling inward into the soil from the body, and meeting at a subsurface blade or ripper blade that is oriented horizontally and that receives and delivers the polymer mesh to the soil.

The features can also include at least one divider (such as mesh divider 370) in the subsurface blade, such as when two separate polymer mesh spools or reels are used. Further, some embodiments feature a soil ripper blade system that can be mounted on any towing vehicle. For instance, the mesh delivery system can include a body (such as body 110 or 410) that moves above ground and is attached to both the subsurface delivery system (or ripper assembly) and to a motorized vehicle (such as motorized vehicle 490), which supplies the motive power to move the body above the ground and the attached ripper assembly below the ground. In some other embodiments, the body itself is motorized to supply the motive power for the subsurface delivery system.

In some embodiments, the features include a transmission or feed system, such as motors, conveyors, channels, and the like, to feed the polymer mesh from within the bladed ripper arms to below the surface. The features can further include at least one spool carrier for holding one or more spools of polymer mesh. In some embodiments, the feature further include adjustable height ripper carriage arms (or ripper arms, such as ripper arms 240, 340, and 440) to vary the depth (delivery depth) of mesh insertion below ground. For example, in some embodiments, the ripper arms move up and down above ground while staying attached to the body through channels, slots, or the like. In some embodiments, the ripper arms telescope in length to reach the desired depth below the ground while remaining at a fixed height above the ground. In some embodiments, the ripper carriage arms or ripper arms are detachable, e.g., to aid with insertion into the earth or soil. Some embodiments further include a ripper blade tilt system (such as ripper blade tilt system 260), e.g., to vary the laying angle of the mesh, or to vary the vertical tilt of the ripper blade (such as to raise or lower the ripper blade from its current depth).

In some embodiments, a towing vehicle (or “vehicle” for short, such as motorized vehicle 490 of FIG. 4) tows or otherwise supplies motive power to the ripper blade system (e.g., through the body that in turn attaches to the ripper assembly) to move the ripper blade through the soil.

In FIG. 1, the polymer mesh delivery system 100 includes a body 110 that moves above ground (in a direction primarily from bottom to top of FIG. 1), a polymer reel 120 coupled to the body 110 and that supplies polymer mesh material, and a subsurface delivery system 130 that receives the supplied polymer mesh while moving through the ground and delivering the supplied polymer mesh as a protective layer of polymer mesh 75 below the ground. For example, the components (such as the body 110) can be a rigid frame constructed from high strength corrosion resistant steel. This configuration may be mounted onto one or more of the ripper system arms (e.g., as shown in FIG. 4). In some embodiments, a small initial trench governed by the dimensions (length and width) of the subsurface delivery system is dug to get the subsurface delivery system 130 into the ground and tethered or tied before the polymer is laid below the surface and without any further trenching.

In FIG. 2, the polymer mesh delivery system 200 moves in a direction primarily from left to right and includes a polymer mesh spool 220 (or rotating spool) that rotates to unroll the polymer mesh material and feed it to one of the height adjustable and detachable angled ripper carriage arms 240 (or blades). The polymer mesh is fed to a ripper blade 250 (bottom horizontal structure) having a ripper blade tilt system 260 to adjust the vertical tilt of the ripper blade 250. In FIG. 3, the polymer mesh delivery system 300 moves in a direction primarily obliquely from upper left to lower right and includes two polymer mesh spools 320 (one on each side of a ripper assembly 330) each supplying polymer mesh 325. The ripper assembly 330 includes two angled ripper blades or arms 340 each adjustable in height and serving as a conduit for the supplied polymer mesh 325, a horizontal ripper blade 350, and a mesh divider 370 embedded in the ripper and that separates and overlaps the two supplied streams of polymer mesh 325 from the polymer mesh spools 320. Accordingly, a polymer mesh protector 75 is delivered behind the ripper blade 350 and that has two layers of polymer mesh 325.

The polymer mesh delivery systems 200 and 300 have vertical and horizontal ripper blades to aid in the movement (or cutting) of the delivery system through the soil or earth. They also feature a tilt mechanism which provides pitch control in the laying of the polymer and height control that allows the user to define the distance between the asset to be protected and the protective polymer mesh. Additionally, protection of buried structures may be reinforced by using a doubled spooled ripper system as shown in FIG. 3. Doubling the layer of polymer mesh on top of the asset to be protected increases the impact resistance of the mesh, to afford further protection. As with the polymer mesh delivery system 100, a small initial trench governed by the dimensions of the subsurface ripper carriage can be dug to get the ripper assembly into the ground. Upon insertion of the horizontal blade above the asset to be protected, the angled vertical ripper blades or arms may be attached or the system can be inserted into the initial trench as a whole unit.

A more complete system may be envisaged through polymer mesh delivery system 400 of FIG. 4, which shows a motorized vehicle 490 attached to height adjustable angled ripper arms 440 (or blades) with an above-ground surface compactor 480 to keep the soil (or earth) compacted above the polymer mesh as it is being delivered or inserted. The polymer mesh protection layer further acts to reinforce the soil, which increases stability of the protected system. Indeed, the delivered polymer mesh of the polymer mesh delivery system can also be used to provide consistency to loose soil.

The above-described and other embodiments provide for no need to dig a trench and back fill it along the length of the asset being protected, as is required with both concrete and polymer slab technologies. In addition to providing for a simple and robust technique, the protective structure formed underground is composed of polymer mesh, which is easy to manufacture. Furthermore, the protective system does not interfere with the cathodic protection in place for the pipeline or other asset, as the spaces between or within the mesh maintains a continuous soil conductivity. In addition, the polymer mesh delivery systems can be made small and lightweight enough to be towed by a general purpose vehicle, and not require a towing vehicle specifically developed for the purpose. These features can lead to cost and time saving, as there is no need to proceed with digging and back filling. The described techniques can provide pipeline protection and encroachment risk mitigation by installing underground protection without digging and backfilling.

In summary, in various embodiments, trenchless polymer mesh delivery systems and methods provide trenchless techniques for the protection of valuable existing buried infrastructure. In addition, different underground mesh patterns can be created that provide different efficiencies to the techniques, which can be used to optimize designs for particular environments. Additionally, the mesh can be made more efficient through different designs of the mesh, such as adding strengthening particles or using hybrid polymer mixes.

With reference to FIGS. 1-4, in some example embodiments, a trenchless system (such as trenchless polymer mesh delivery system 100, 200, 300, or 400) for subsurface delivery of a polymer-based mesh (such as polymer mesh 325) to protect an underground structure (such as buried pipeline 50) is provided. The system includes a body (such as body 110 or 410) for moving above the ground (such as ground 25) and over the underground structure while the system delivers the polymer-based mesh below the ground (such as deposited polymer mesh 75). In addition, the system includes a polymer mesh supply (such as polymer mesh spool 120, 220, or 320) coupled to the body and that supplies the mesh during the moving of the body. The system further includes a ripper assembly (such as subsurface delivery system 130 or ripper assembly 330) coupled to the body and that moves through the ground in response to the moving of the body without digging a trench and while receiving and delivering the supplied mesh below the ground and above the underground structure to protect the underground structure.

In some embodiments, the polymer mesh supply comprises a polymer mesh spool (such as rotating spool 220) that rotates during the moving of the body in order to supply the mesh. In some other embodiments, the polymer mesh supply is some other arrangement, such as a box or other container of folded polymer mesh, or strands of polymer that are formed (e.g., wovern) into a polymer mesh as part of the supplying of the polymer mesh. In some embodiments, the ripper assembly includes a first ripper arm (such as ripper arm 240, 340, or 440) coupled to the body and that: extends into and moves through the ground in response to the moving of the body; and serves as a conduit (e.g., a channel or sleeve) for the supplied mesh from the polymer mesh supply to a delivery depth below the ground (and above the underground structure being protected). The ripper assembly further includes a second ripper arm coupled to the body and that extends into and moves through the ground in response to the moving of the body. In addition, the ripper assembly includes a ripper blade (such as ripper blade 250 or 350) coupled to the first and second ripper arms and that moves through the ground at the delivery depth in response to the moving of the extended first and second ripper arms, and receives and delivers the supplied mesh from the extended first ripper arm at the delivery depth below the ground.

In some embodiments, the ripper blade includes a tilt system (such as ripper blade tilt system 260) for adjusting a vertical tilt (such as pitch) of the ripper blade during the moving of the ripper blade. In some embodiments, the first and second ripper arms adjust the delivery depth below the ground in response to adjusting the vertical tilt of the ripper blade while the body remains fixed in height above the ground. In some such embodiments, the first and second ripper arms adjust in height above the ground in response to adjusting the vertical tilt of the ripper blade while the body remains fixed in height above the ground. In some embodiments, the first and second ripper arms detach from and attach to the body before the moving of the body (such as before or after delivering the layer of subsurface polymer mesh above the underground structure).

In some embodiments, the polymer mesh supply includes a first polymer mesh supply (such as the left polymer mesh spool 320) that supplies the mesh to the first ripper arm, and a second polymer mesh supply (such as the right polymer mesh spool 320) that supplies the mesh to the second ripper arm. In addition, the first ripper arm serves as a conduit for the supplied mesh from the first polymer mesh supply to the ripper blade at the delivery depth below the ground, while the second ripper arm serves as a conduit for the supplied mesh from the second polymer mesh supply to the ripper blade at the delivery depth below the ground. The ripper blade receives and delivers the supplied mesh from the second ripper arm at the delivery depth below the ground. In some such embodiments, the first polymer mesh supply includes a first polymer mesh spool that rotates while the body moves in order to supply the mesh to the first ripper arm, while the second polymer mesh supply includes a second polymer mesh spool that rotates while the body moves in order to supply the mesh to the second ripper arm.

In some embodiments, the ripper blade includes a divider (such as mesh divider 370) that separates the supplied mesh from the first and second ripper arms, such that the ripper blade overlaps (as in doubles the polymer mesh layering of) the separated mesh supplied from the first and second ripper arms at the delivery depth below the ground. In some embodiments, the first and second ripper arms angle inward from the body to the ripper blade while extending into the ground such that the extended first and second ripper arms are closer to each other at the delivery depth below the ground than at a height above the ground. In some embodiments, the body includes an attachment point (or points or surface) for attaching the body to a motorized vehicle (such as motorized vehicle 490) that supplies a driving force for moving the body above the ground while the system delivers the mesh below the ground. In some embodiments, the system further includes a surface compactor coupled to the body and that compacts the surface of the ground below the body during the moving of the body.

The described techniques herein can be implemented using a combination of sensors, cameras, GPRs, and other devices including computing or other logic circuits configured (e.g., programmed) to carry out their assigned tasks. These devices are located on or in (or otherwise in close proximity to) the motorized vehicle or body or processing circuitry for carrying out the techniques. In some example embodiments, the control logic is implemented as computer code configured to be executed on a computing circuit (such as a microprocessor) to perform the control steps that are part of the technique.

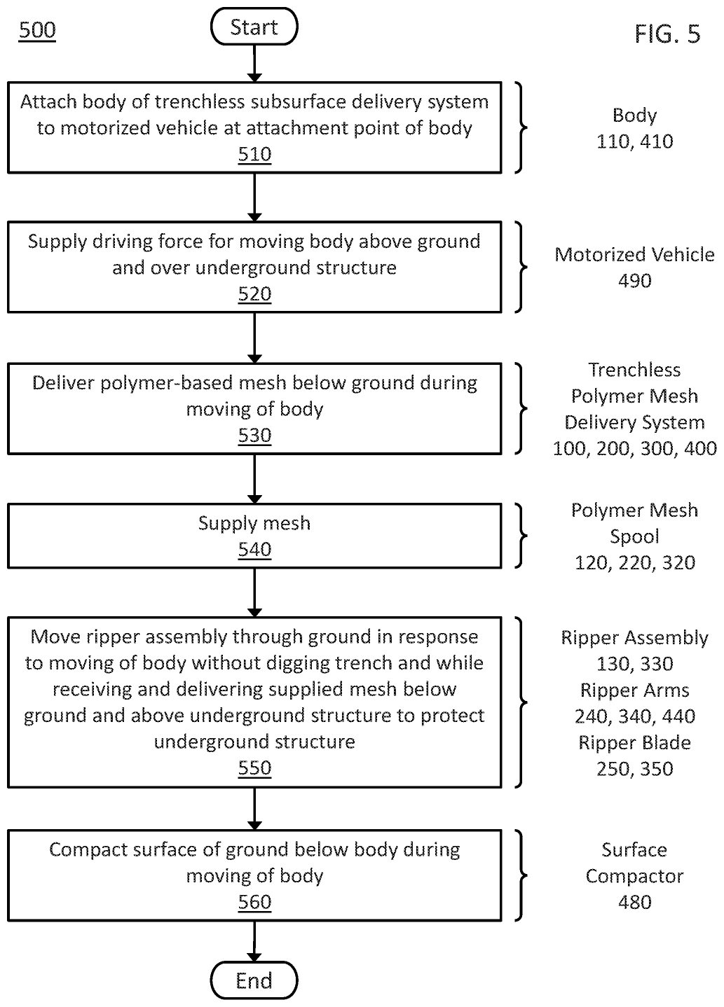

FIG. 5 is a flow diagram of an example method 500 of trenchless subsurface delivery of a polymer-based mesh (such as polymer mesh 325, as in HDPE mesh) to protect an underground structure (such as buried pipeline 50), according to an embodiment.

Some or all of the method 500 can be performed using components and techniques illustrated in FIGS. 1 through 4. In addition, portions of this and other methods disclosed herein can be performed on or using a custom or preprogrammed logic device, circuit, or processor, such as a programmable logic circuit (PLC), computer, software, or other circuit (e.g., ASIC, FPGA) configured by code or logic to carry out their assigned task. The device, circuit, or processor can be, for example, a dedicated or shared hardware device (such as a laptop, a single board computer (SBC), a workstation, a tablet, a smartphone, part of a server, or a dedicated hardware circuit, as in an FPGA or ASIC, or the like), or computer server, or a portion of a server or computer system. The device, circuit, or processor can include a non-transitory computer readable medium (CRM, such as read-only memory (ROM), flash drive, or disk drive) storing instructions that, when executed on one or more processors, cause portions of the method 500 (or other disclosed method) to be carried out. It should be noted that in other embodiments, the order of the operations can be varied, and that some of the operations can be omitted. Some of the method 500 can also be performed using logic, circuits, or processors located on or in electrical communication with a processing circuit configured to carry out the method 500.

In the method 500, processing begins with the step of attaching 510 a body (such as body 110 or 410) of a polymer mesh delivery system (such as trenchless polymer mesh delivery system 100, 200, 300, or 400) to a motorized vehicle (such as motorized vehicle 490) at an attachment point (such as a hitch) of the body. The method 500 further includes the step of supplying 520, by the motorized vehicle, a driving force (such as transport by wheels or treads) for moving the body above the ground (such as ground 25) and over the underground structure while the system performs the step of delivering 530 the polymer-based mesh below the ground. The step of delivering 530 the mesh includes the steps of supplying 540 the mesh from a polymer mesh supply (such as polymer mesh spool 120, 220, or 320) coupled to the body, and moving 550 a ripper assembly (such as ripper assembly 130 or 330) through the ground in response to the moving of the body. This movement of the ripper assembly takes place without digging a trench and while receiving and delivering the supplied mesh below the ground and above the underground structure to protect the underground structure. Here, the ripper assembly is coupled to the body. In addition, the method 500 includes the step of compacting 560, by a surface compactor (such as above-ground surface compactor 480) coupled to the body, the surface of the ground below the body during the moving of the body.

In some embodiments, the polymer mesh supply includes a polymer mesh spool, and the step of supplying 540 the mesh includes the step of rotating the polymer mesh spool during the moving of the body. In some embodiments, the step of delivering 530 the mesh further includes the steps of extending a first ripper arm (such as ripper arm 240, 340 or 440) of the ripper assembly into the ground and moving the extended first ripper arm through the ground in response the to the moving of the body, the first ripper arm being coupled to the body. In addition, the step of delivering 530 the mesh includes the step of using the extended first ripper arm as a conduit for the supplied mesh from the polymer mesh supply to a delivery depth below the ground. The step of delivering 530 the mesh further includes the steps of extending a second ripper arm (such as another ripper arm 240, 340 or 440) of the ripper assembly into the ground and moving the extended second ripper arm through the ground in response the to the moving of the body, the second ripper arm being coupled to the body. In addition, the step of delivering 530 the mesh includes the step of moving a ripper blade (such as ripper blade 250 or 350) of the ripper assembly through the ground at the delivery depth in response to the moving of the extended first and second ripper arms, the ripper blade being coupled to the first and second ripper arms. The step of delivering 530 the mesh further includes the steps of receiving and delivering the supplied mesh from the extended first ripper arm by the moving ripper blade at the delivery depth below the ground.

In some embodiments, the method 500 further includes the step of adjusting a vertical tilt of the ripper blade using a tilt system (such as ripper blade tilt system 260) of the ripper blade during the moving of the ripper blade. In some such embodiments, the method 500 further includes the step of adjusting the delivery depth below the ground of the first and second ripper arms in response to adjusting the vertical tilt of the ripper blade while the body remains fixed in height above the ground. In some embodiments, the method 500 further includes the step of adjusting a height above the ground of the first and second ripper arms in response to adjusting the vertical tilt of the ripper blade while the body remains fixed in height above the ground. In some embodiments, the method 500 further includes the step of detaching the first and second ripper arms from the body and attaching the first and second ripper arms to the body before the moving of the body.

In some embodiments, the step of delivering 530 the mesh further includes the steps of supplying the mesh to the first ripper arm by a first polymer mesh supply of the polymer mesh supply, supplying the mesh to the second ripper arm by a second polymer mesh supply of the polymer mesh supply, using the extended first ripper arm as a conduit for the supplied mesh from the first polymer mesh supply to the ripper blade at the delivery depth below the ground, using the extended second ripper arm as a conduit for the supplied mesh from the second polymer mesh supply to the ripper blade at the delivery depth below the ground, and receiving and delivering the supplied mesh from the extended second ripper arm by the moving ripper blade at the delivery depth below the ground. In some such embodiments, the first polymer mesh supply includes a first polymer mesh spool and the second polymer mesh supply includes a second polymer mesh spool, and the step of supplying 540 the mesh includes rotating the first and second polymer mesh spools during the moving of the body.

In some embodiments, the step of delivering 530 the mesh further includes the steps of: separating, by a divider of the ripper blade, the supplied mesh from the first and second ripper arms; and overlapping, by the ripper blade, the separated mesh supplied from the first and second ripper arms at the delivery depth below the ground. In some embodiments, the step of delivering 530 the mesh further includes the steps of angling the first and second ripper arms inward from the body to the ripper blade while extending into the ground such that the extended first and second ripper arms are closer to each other at the delivery depth below the ground than at a height above the ground.

The methods described herein may be performed in part by software or firmware in machine readable form on a tangible (e.g., non-transitory) storage medium. For example, the software or firmware may be in the form of a computer program including computer program code adapted to perform some of the steps of any of the methods described herein when the program is run on a computer or suitable hardware device (e.g., FPGA), and where the computer program may be embodied on a computer readable medium. Examples of tangible storage media include computer storage devices having computer-readable media such as disks, thumb drives, flash memory, and the like, and do not include propagated signals. Propagated signals may be present in a tangible storage media, but propagated signals by themselves are not examples of tangible storage media. The software can be suitable for execution on a parallel processor or a serial processor such that the method steps may be carried out in any suitable order, or simultaneously.

It is to be further understood that like or similar numerals in the drawings represent like or similar elements through the several figures, and that not all components or steps described and illustrated with reference to the figures are required for all embodiments or arrangements.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to a viewer. Accordingly, no limitations are implied or to be inferred. In addition, the use of ordinal numbers (e.g., first, second, third) is for distinction and not counting. For example, the use of “third” does not imply there is a corresponding “first” or “second.” Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. A trenchless system for subsurface delivery of a polymer-based mesh to protect an underground structure, the system comprising:
a body for moving above the ground and over the underground structure while the system delivers the polymer-based mesh below the ground;
a polymer mesh supply coupled to the body and configured to supply the mesh during the moving of the body; and
a ripper assembly coupled to the body and configured to move through the ground in response to the moving of the body without digging a trench and while receiving and delivering the supplied mesh below the ground and above the underground structure to protect the underground structure.

2. The system of claim 1, wherein the polymer mesh supply comprises a polymer mesh spool configured to rotate during the moving of the body in order to supply the mesh.

3. The system of claim 1, wherein the ripper assembly comprises:
a first ripper arm coupled to the body and configured to:
extend into and move through the ground in response to the moving of the body; and
serve as a conduit for the supplied mesh from the polymer mesh supply to a delivery depth below the ground;
a second ripper arm coupled to the body and configured to extend into and move through the ground in response to the moving of the body; and
a ripper blade coupled to the first and second ripper arms and configured to:
move through the ground at the delivery depth in response to the moving of the extended first and second ripper arms; and
receive and deliver the supplied mesh from the extended first ripper arm at the delivery depth below the ground.

4. The system of claim 3, wherein the ripper blade comprises a tilt system for adjusting a vertical tilt of the ripper blade during the moving of the ripper blade.

5. The system of claim 4, wherein the first and second ripper arms are configured to adjust the delivery depth below the ground in response to adjusting the vertical tilt of the ripper blade while the body remains fixed in height above the ground.

6. The system of claim 5, wherein the first and second ripper arms are further configured to adjust in height above the ground in response to adjusting the vertical tilt of the ripper blade while the body remains fixed in height above the ground.

7. The system of claim 3, wherein the first and second ripper arms are configured to detach from and attach to the body before the moving of the body.

8. The system of claim 3, wherein:
the polymer mesh supply comprises a first polymer mesh supply configured to supply the mesh to the first ripper arm, and a second polymer mesh supply configured to supply the mesh to the second ripper arm;
the first ripper arm is further configured to serve as a conduit for the supplied mesh from the first polymer mesh supply to the ripper blade at the delivery depth below the ground;
the second ripper arm is further configured to serve as a conduit for the supplied mesh from the second polymer mesh supply to the ripper blade at the delivery depth below the ground; and
the ripper blade is further configured to receive and deliver the supplied mesh from the second ripper arm at the delivery depth below the ground.

9. The system of claim 8, wherein:
the first polymer mesh supply comprises a first polymer mesh spool configured to rotate while the body moves in order to supply the mesh to the first ripper arm; and
the second polymer mesh supply comprises a second polymer mesh spool configured to rotate while the body moves in order to supply the mesh to the second ripper arm.

10. The system of claim 8, wherein
the ripper blade comprises a divider configured to separate the supplied mesh from the first and second ripper arms; and
the ripper blade is further configured to overlap the separated mesh supplied from the first and second ripper arms at the delivery depth below the ground.

11. The system of claim 3, wherein the first and second ripper arms are further configured to angle inward from the body to the ripper blade while extending into the ground such that the extended first and second ripper arms are closer to each other at the delivery depth below the ground than at a height above the ground.

12. The system of claim 1, wherein the body comprises an attachment point for attaching the body to a motorized vehicle configured to supply a driving force for moving the body above the ground while the system delivers the mesh below the ground.

13. The system of claim 1, further comprising a surface compactor coupled to the body and configured to compact the surface of the ground below the body during the moving of the body.

14. A method of trenchless subsurface delivery of a polymer-based mesh to protect an underground structure, the method comprising:
moving a body of a polymer mesh delivery system above the ground and over the underground structure; and
delivering the polymer-based mesh below the ground by the system during the moving of the body, wherein delivering the mesh comprises:
supplying the mesh from a polymer mesh supply coupled to the body; and
moving a ripper assembly through the ground in response to the moving of the body without digging a trench and while receiving and delivering the supplied mesh below the ground and above the underground structure to protect the underground structure,
wherein the ripper assembly is coupled to the body.

15. The method of claim 14, wherein the polymer mesh supply comprises a polymer mesh spool, and supplying the mesh comprises rotating the polymer mesh spool during the moving of the body.

16. The method of claim 14, wherein delivering the mesh further comprises:
extending a first ripper arm of the ripper assembly into the ground and moving the extended first ripper arm through the ground in response the to the moving of the body, the first ripper arm being coupled to the body:
using the extended first ripper arm as a conduit for the supplied mesh from the polymer mesh supply to a delivery depth below the ground;
extending a second ripper arm of the ripper assembly into the ground and moving the extended second ripper arm through the ground in response the to the moving of the body, the second ripper arm being coupled to the body:
moving a ripper blade of the ripper assembly through the ground at the delivery depth in response to the moving of the extended first and second ripper arms, the ripper blade being coupled to the first and second ripper arms; and
receiving and delivering the supplied mesh from the extended first ripper arm by the moving ripper blade at the delivery depth below the ground.

17. The method of claim 16, further comprising adjusting a vertical tilt of the ripper blade using a tilt system of the ripper blade during the moving of the ripper blade.

18. The method of claim 17, further comprising adjusting the delivery depth below the ground of the first and second ripper arms in response to adjusting the vertical tilt of the ripper blade while the body remains fixed in height above the ground.

19. The method of claim 18, further comprising adjusting a height above the ground of the first and second ripper arms in response to adjusting the vertical tilt of the ripper blade while the body remains fixed in height above the ground.

20. The method of claim 16, further comprising detaching the first and second ripper arms from and attaching the first and second ripper arms to the body before the moving of the body.

21. The method of claim 16, wherein delivering the mesh further comprises:
supplying the mesh to the first ripper arm by a first polymer mesh supply of the polymer mesh supply;
supplying the mesh to the second ripper arm by a second polymer mesh supply of the polymer mesh supply;
using the extended first ripper arm as a conduit for the supplied mesh from the first polymer mesh supply to the ripper blade at the delivery depth below the ground;
using the extended second ripper arm as a conduit for the supplied mesh from the second polymer mesh supply to the ripper blade at the delivery depth below the ground; and
receiving and delivering the supplied mesh from the extended second ripper arm by the moving ripper blade at the delivery depth below the ground.

22. The method of claim 21, wherein the first polymer mesh supply comprises a first polymer mesh spool and the second polymer mesh supply comprises a second polymer mesh spool, and supplying the mesh comprises rotating the first and second polymer mesh spools during the moving of the body.

23. The method of claim 21, wherein delivering the mesh further comprises:
separating, by a divider of the ripper blade, the supplied mesh from the first and second ripper arms; and
overlapping, by the ripper blade, the separated mesh supplied from the first and second ripper arms at the delivery depth below the ground.

24. The method of claim 16, wherein delivering the mesh further comprises angling the first and second ripper arms inward from the body to the ripper blade while extending into the ground such that the extended first and second ripper arms are closer to each other at the delivery depth below the ground than at a height above the ground.

25. The method of claim 14, further comprising:
attaching the body to a motorized vehicle at an attachment point of the body; and
supplying, by the motorized vehicle, a driving force for moving the body above the ground while the system delivers the mesh below the ground.

26. The method of claim 14, further comprising compacting, by a surface compactor coupled to the body, the surface of the ground below the body during the moving of the body.
